(19) United States
(12) Patent Application Publication
(10) Pub. No.: US 2006/0095786 A1
(43) Pub. Date: May 4, 2006

(54) Communication networks and methods and computer program products for preventing tracking of network activity thereon through use of identity pseudonym domains

(76) Inventor: Jeffrey A. Aaron, Atlanta, GA (US)

Correspondence Address: MYERS BIGEL SIBLEY & SAJOVEC, P.A., P.O. BOX 37428, RALEIGH, NC, 27627, US

(21) Appl. No.: 10/978,618

(22) Filed: Nov. 1, 2004

(51) Int. Cl. H04K 1/00

(52) U.S. Cl. 713/184

(57) ABSTRACT

A communication network is operated by associating a first pseudonym with a user of the communication network in a customer domain. A second pseudonym is associated with the user in a customer-contact domain. Communications between the user and a customer-contact associated with the customer-contact domain are translated by mapping the first pseudonym and the second pseudonym to each other.

### FIELD OF THE INVENTION

The present invention relates to communication networks and methods of operating the same, and, more particularly, to tracking user activity on communication networks.

### BACKGROUND OF THE INVENTION

Communications networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

The Internet is a decentralized network of computers that can communicate with one another via Internet Protocol (IP). The Internet includes the World Wide Web (WWW) service facility, which is a client/server-based facility that includes a large number of servers (computers connected to the Internet) on which Web pages or files reside, as well as clients (Web browsers), which interface users with the Web pages. The topology of the World Wide Web can be described as a network of networks, with providers of network services called Network Service Providers, or NSPs. Servers that provide application-layer services may be referred to as Application Service Providers (ASPs). Sometimes a single service provider provides both functions.

Due to the public accessibility of modern communications networks, users of these networks may be concerned with security and/or privacy. Service providers, however, may desire to profile and/or keep track of customer actions and activities for many valid reasons. These reasons may include enabling the provider to more efficiently, effectively, and/or satisfactorily offer the customer additional services. Even with existing services already provided to the customer, tracking and profiling that help the provider know the customer better may enable those existing services to be provided in an improved manner. In fact, some services and particularly some new Internet Protocol (IP) based or network-provided services may require tracking and/or profiling of customers to properly function. Customers, however, may be increasingly concerned with privacy, and, in many cases, may not want such information to be collected because it may be associated with them and subsequently used in ways that they may consider annoying or even harmful. Current methods of tracking and profiling typically associate the collected information directly with customer identities or other customer information, which could in theory or practice by associated with the individual customer, such that the customer must unfortunately rely entirely on provider promises that annoying or harmful uses will not be allowed or will be limited. Many customers, however, may not trust conventional tracking and profiling systems to protect their privacy.

### SUMMARY OF THE INVENTION

According to some embodiments of the present invention, a communication network is operated by associating a first pseudonym with a user of the communication network in a customer domain. A second pseudonym is associated with the user in a customer-contact domain. Communications between the user and a customer-contact associated with the customer-contact domain are translated by mapping the first pseudonym and the second pseudonym to each other. Customer contacts may include stores, shippers, billing and/or financial service providers, service providers in general, and any other entities participating in a transaction with the customer and/or on the customer's behalf and/or for the customer's benefit.

In other embodiments, associating the first pseudonym comprises hashing identification information of the user with customer domain information to generate the first pseudonym. Associating the second pseudonym comprises hashing identification information of the user with customer-contact domain information to generate the second pseudonym.

In still other embodiments, hashing identification information of the user with customer domain information comprises hashing identification information of the user with customer domain information and customer domain salt data to generate the first pseudonym. Hashing identification information of the user with customer-contact domain information comprises hashing identification information of the user with customer-contact domain information and customer-contact salt data to generate the second pseudonym.

In still other embodiments, translating communications between the user and the customer-contact associated with the customer-contact domain comprises mapping the first pseudonym and a translator domain pseudonym to each other and mapping the translator domain pseudonym and the second pseudonym to each other.

In still other embodiments, the translator domain pseudonym is ephemeral.

In still other embodiments, the translator domain pseudonym is valid for a defined period of time and/or a defined set of communications between the user and the customer contact.

In still other embodiments, identification information of the user is hashed with translator-domain information to generate the translator domain pseudonym.

In still other embodiments, the first pseudonym is changed and the change in the first pseudonym is detected. Communications between the user and the customer-contact associated with the customer-contact domain are translated by mapping the changed first pseudonym and the second pseudonym to each other.

In still other embodiments, mapping the first pseudonym and the second pseudonym to each other comprises electronically mapping the first pseudonym and the second pseudonym to each other.

In still other embodiments, mapping the first pseudonym and the second pseudonym to each other comprises physically mapping the first pseudonym and the second pseudonym to each other.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention;

FIG. 2 illustrates a data processing system that may be used to implement various servers of the communication network of FIG. 1 in accordance with some embodiments of the present invention; and

FIG. 3 is a flowchart that illustrates operations for preventing tracking of network activities of a user through use of identity pseudonym domains in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

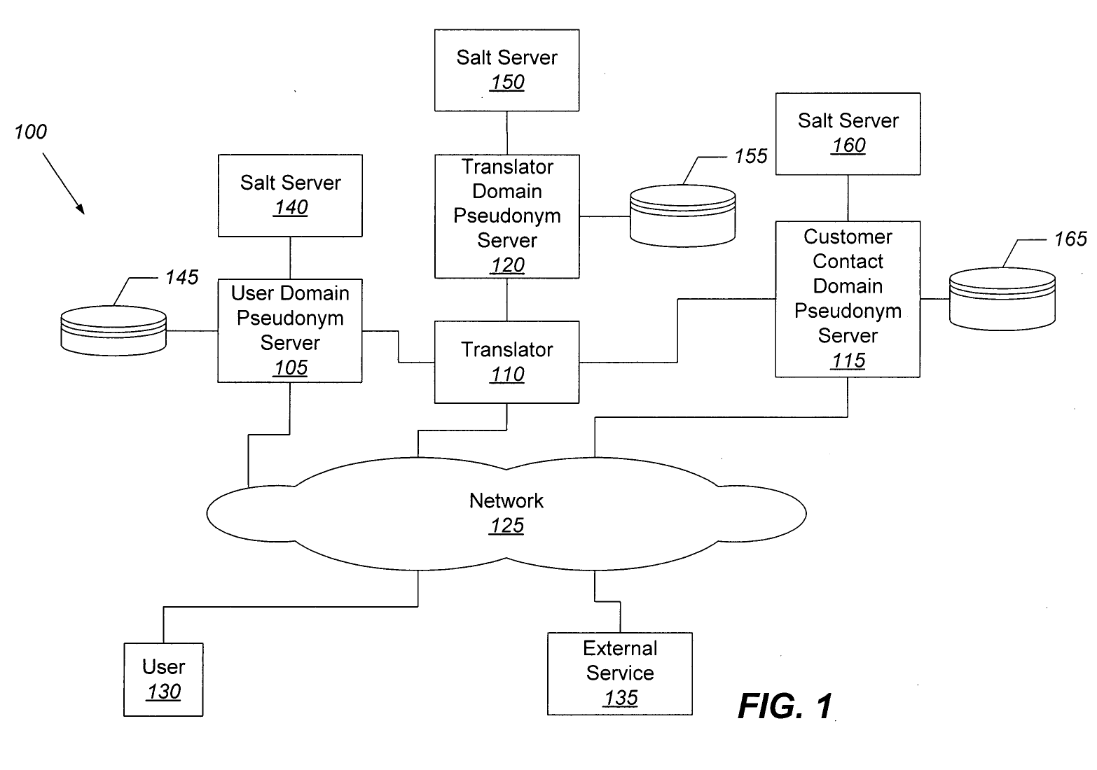

Referring now to FIG. 1, an exemplary network architecture 100 for preventing tracking of network activities of a user through use of identity pseudonym domains, in accordance with some embodiments of the present invention, comprises a user domain pseudonym server 105, a translator 110, a customer-contact domain pseudonym server 115, and a translator domain pseudonym server 120 that are connected as shown to a network 125. A user 130 and an external service 135 are also connected to the network 125 and use the network 125 to communicate with each other. The network 125 may represent a global network, such as the Internet, or other publicly accessible network. The network 125 may also, however, represent a wide area network, a local area network, an Intranet, or other private network, which may not accessible by the general public. Furthermore, the network 125 may represent a combination of public and private networks or a virtual private network (VPN). The various domains may be physically separated domains connected by translators, or may be logically separated using well-known mechanisms/techniques on a common network as shown in the exemplary architecture of FIG. 1, or may be physically and logically separated. Domain separation is generally desirable in accordance with some embodiments of the present invention. All interactions between different domains may occur via translators.

Advantageously, the use of multiple pseudonyms for the user's 130 identity may provide enhanced privacy protection for the user 130. That is, in transactions between the user 130 and the external service 135 and other service providers, only a reduced portion of identity data is provided to any external service 135 or party to allow that service provider/party to perform a specified function. No one entity may have sufficient identity data to make any privacy-impacting association.

The user domain pseudonym server 105, the translator domain pseudonym server 120, and the customer-contact domain pseudonym server 115 may obtain respective pseudonyms for the user 130 in the various domains (i.e., user, translator, and customer-contact). For example, the user 130 may sign up for privacy-assured service through a provider. Optionally, the user domain pseudonym server 105 may provide the user 130 with a private key during sign up to prevent others from impersonating the user 130, where the private key is used to facilitate public-private cryptography methods of authentication/authorization/encryption/digital signing as is generally known in the art.

The user domain pseudonym server 105 may be configured to generate a pseudonym for the user 130 using conventional hash algorithms, such as the Secure Hash Algorithm (SHA-1), and/or the various Message Digest (MD2, MD4, MD5) algorithms. To ensure uniqueness of the generated pseudonyms, the user domain pseudonym server 105 may use the salt server 140 to provide a “salt,” which may be random data that can be used in the hash algorithm.

The user domain pseudonym server 105 may store the user's 130 pseudonym in a database 145, but may store the user's 130 actual identity separately (e.g., in different portions of the same database 145 or in a different database) or may subsequently destroy the user's 130 actual identity to protect the user's 140 privacy.

The generation of the pseudonym at the user domain pseudonym server 105 may trigger generation of pseudonyms for the user 130 in both the translator and customer-contact domains in accordance with some embodiments of the present invention. For example, the user domain pseudonym server 105 may send a synchronization message to the translator 110 containing the new pseudonym for the user 130. The translator 110 may obtain a translation pseudonym that is generated by the translator domain pseudonym server 120, salt server 150, and database 155. The translator 110 may update its mapping table to map the user domain pseudonym to the translation pseudonym. The translator 110 sends a message to the customer-contact domain pseudonym server 115, which, in cooperation with the salt server 160 and the database 165, generates a customer-contact domain pseudonym for the user 130. The customer-contact domain pseudonym server 115 sends the customer-contact domain pseudonym to the translator, updates its mapping table to map the customer-contact domain pseudonym to the translator pseudonym. In this manner, changes to existing pseudonyms or the creation of new pseudonyms can be rippled through the communication network and the various domains. Pseudonyms may, thus, be changed periodically, for example, once each week, to improve the robustness of security and privacy.

In accordance with some embodiments of the present invention, the translator pseudonym may be ephemeral to reduce the changes of hacking or exploitation by an intruder. That is, the translator domain pseudonym may be valid for a defined period of time and/or a defined set of communications and/or transactions between the user 130 and the external service 135, for example. The defined set of communications may be associated with a particular service provider and/or customer. The use of ephemeral pseudonyms may increase system complexity and may be computationally more expensive, but may provide sufficient advantage to warrant use.

Although FIG. 1 illustrates an exemplary communication network, it will be understood that the present invention is not limited to such configurations, but is intended to encompass any configuration capable of carrying out the operations described herein.

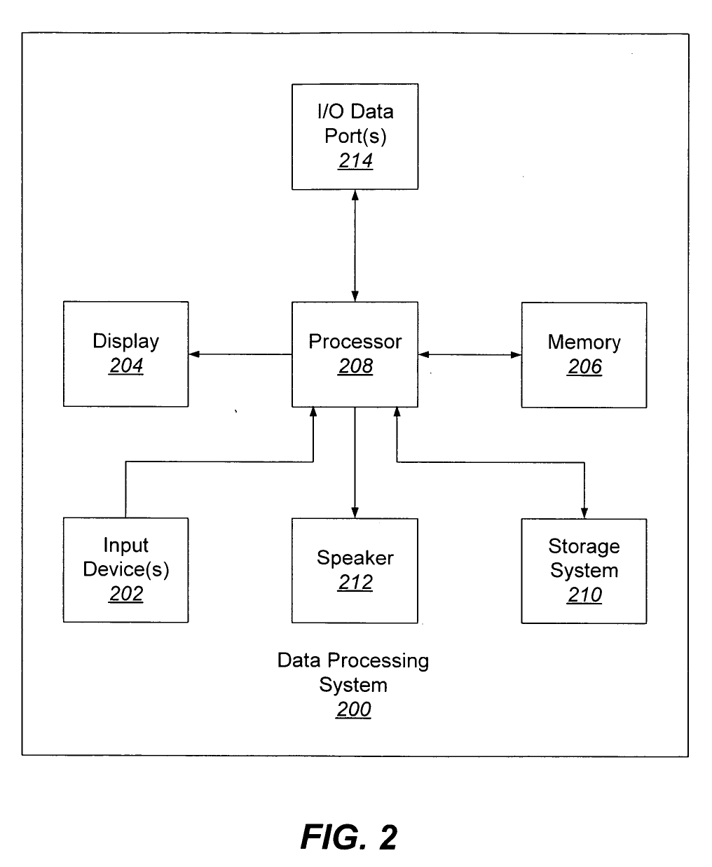

Referring now to FIG. 2, a data processing system 200 that may be used to implement the user domain pseudonym server 105, translator 110, translator domain pseudonym server 120, customer-contact domain pseudonym server 115, salt servers 140, 150, and 160, user 140, and/or external service 145 of FIG. 1, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components such as those used in many conventional computing devices, which may be configured to operate as described herein.

Computer program code for carrying out operations of data processing systems discussed above with respect to FIGS. 1 and 2 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

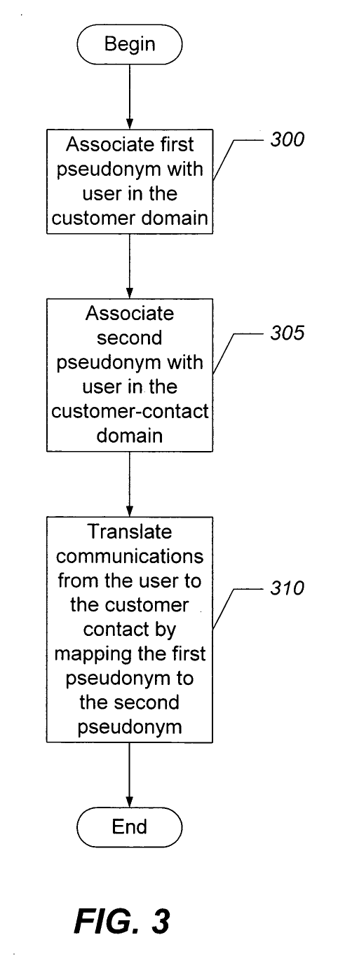

Exemplary operations for operations for preventing tracking of network activities of a user through use of identity pseudonym domains will now be described with reference to FIGS. 3 and 1. Operations begin at block 300 where the user domain pseudonym server 105 associates a first pseudonym with the user 130 in the user domain. At block 305, the customer-contact domain pseudonym server 115 associates a second pseudonym with the user 130 in the customer-contact domain. The translator 110 translates communications from the user 130 to the external service (e.g., customer contact) by mapping the first pseudonym to the second pseudonym at block 310.

In accordance with some embodiments of the present invention, the user domain pseudonym server 105 associates the first pseudonym with the user 130 by hashing identification information of the user 130 with customer domain information and, optionally, salt data to generate the first pseudonym. Similarly, the customer-contact domain pseudonym server 115 associates the second pseudonym with the user 130 by hashing identification information of the user with customer-contact domain information and, optionally, salt data to generate the second pseudonym.

When translating communications between the user domain and the customer-contact domain, the translator 110 may map the first pseudonym to a translator domain pseudonym and map the translator domain pseudonym to the second pseudonym. The translator domain pseudonym may be generated by hashing identification information of the user 130 with translator domain information and, optionally, salt data. In some embodiments, for improved security, a sequential set of two or more translators may be used for translation and to facilitate interactions and updating between domains rather than using one translator. Furthermore, different translators may be used between different sets of domains. Also, one single customer-contact domain may be used for all customer contacts, or a different unique customer-contact domain may be used for each different customer contact, or some combination between these two approaches may be used, for example, a different unique customer-contact domain used for each different type of customer contact.

In accordance with various embodiments of the present invention, the translator 110 may represent both electronic mapping of pseudonyms from the user domain to the customer-contact domain and also physical mapping of pseudonyms between the user domain and the customer contact domain. For example, a package may be marked, for example by an on-line store, with a pseudonym recognizable by a shipper's domain. The shipper for the on-line store, once receiving the package, may use the pseudonym to look up the address, but no other identity information, such as a user's name.

Thus, in general, information, including identity information, may be indexed or associated with a pseudonym in a particular domain. This limited information may be used by the entity associated with that domain, but may not be, and typically should not be, sufficient to derive the complete identity of a user or customer. The limited identity information provided to each domain may be minimal in accordance with some embodiments of the present invention. For example, an email provider may be given only an email address and may operate only on email. A physical or electronic store may be given no identity information and may operate only on the item purchased and its bill. A billing provider may be provided with an account number and may operate only that account. Mail/package delivery services may be provided only with an address and may operate only on the item being mailed. Indexing to each domain's pseudonyms, synchronizing the various pseudonyms used across all the various domains, and allowing interactions between domains to occur via translators may serve to functionally tie together the activities in each domain so that the user is able to accomplish useful actions privately.

The flowchart of FIG. 3 illustrates the architecture, functionality, and operations of some embodiments of methods, systems, and computer program products for preventing tracking of network activities of a user through use of identity pseudonym domains. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

Some embodiments of the present invention may be illustrated by way of example. A customer or user 130 may sign up with a privacy-assurance service for navigating the network 125. The user 130 may receive client software to assist in digitally signing messages and to setup individual preferences. The user's 130 communications to a bookstore (e.g., external service 135) are intercepted by the translator 110 so that the bookstore does not know the user's 130 identity other than the user's 130 pseudonym in the customer-contact domain. The user 130 purchases a book and the bookstore consults an appropriate translator to determine the needed bookstore to shipper translator domain pseudonym for the user 130. The bookstore marks the package with the store name and the shipper's translator domain pseudonym for the user 130. The shipper uses the shipper translator domain pseudonym for the user 130 to determine the user's address. The package is sent to the user 130 at his/her address without any name on the package other than a pseudonym. Similarly, the bill is sent electronically via the appropriate translators to the user's 130 selected billing provider. Using the user's 130 billing domain pseudonym, the billing provider is able to obtain the user's 130 credit card number to bill the purchase from the bookstore to that account, but without necessarily knowing other user identity information.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
associating a first pseudonym with a user of the communication network in a customer domain;
associating a second pseudonym with the user in a customer-contact domain; and
translating communications between the user and a customer-contact associated with the customer-contact domain by mapping the first pseudonym and the second pseudonym to each other.

2. The method of claim 1, wherein associating the first pseudonym comprises:
hashing identification information of the user with customer domain information to generate the first pseudonym; and
wherein associating the second pseudonym comprises:
hashing identification information of the user with customer-contact domain information to generate the second pseudonym.

3. The method of claim 2, wherein hashing identification information of the user with customer domain information comprises:
hashing identification information of the user with customer domain information and customer domain salt data to generate the first pseudonym; and
wherein hashing identification information of the user with customer-contact domain information comprises:
hashing identification information of the user with customer-contact domain information and customer-contact salt data to generate the second pseudonym.

4. The method of claim 1, wherein translating communications between the user and the customer-contact associated with the customer-contact domain comprises:
mapping the first pseudonym and a translator domain pseudonym to each other; and
mapping the translator domain pseudonym and the second pseudonym to each other.

5. The method of claim 4, wherein the translator domain pseudonym is ephemeral.

6. The method of claim 5, wherein the translator domain pseudonym is valid for a defined period of time and/or a defined set of communications between the user and the customer contact.

7. The method of claim 4, further comprising:
hashing identification information of the user with translator-domain information to generate the translator domain pseudonym.

8. The method of claim 1, further comprising:
changing the first pseudonym;
detecting the change in the first pseudonym; and
wherein translating communications between the user and the customer-contact associated with the customer-contact domain by mapping the first pseudonym and the second pseudonym to each other comprises translating communications between the user and the customer-contact associated with the customer-contact domain by mapping the changed first pseudonym and the second pseudonym to each other.

9. The method of claim 1, wherein mapping the first pseudonym and the second pseudonym to each other comprises electronically mapping the first pseudonym and the second pseudonym to each other.

10. The method of claim 1, wherein mapping the first pseudonym and the second pseudonym to each other comprises physically mapping the first pseudonym and the second pseudonym to each other.

11. A communications network, comprising:
a user domain pseudonym server that is configured to associate a first pseudonym with a user of the communication network in a customer domain;
a customer-contact domain pseudonym server that is configured to associate a second pseudonym with the user in a customer-contact domain; and
a translator that is connected to the user domain pseudonym server and the customer-contact domain pseudonym server and is configured to translate communications between the user and a customer-contact associated with the customer-contact domain by mapping the first pseudonym and the second pseudonym to each other.

12. The communications network of claim 11, wherein the user domain pseudonym server is further configured to hash identification information of the user with customer domain information and customer domain salt data to generate the first pseudonym; and wherein the customer-contact domain pseudonym server is further configured to hash identification information of the user with customer-contact domain information and customer-contact salt data to generate the second pseudonym.

13. The communications network of claim 11, wherein the translator is further configured to map the first pseudonym to a translator domain pseudonym and map the translator domain pseudonym to the second pseudonym.

14. The communications network of claim 13, wherein the translator domain pseudonym is ephemeral.

15. The communications network of claim 14, wherein the translator domain pseudonym is valid for a defined period of time and/or a defined set of communications and/or transactions between the user and the customer contact.

16. The communications network of claim 11, wherein the user domain pseudonym server is further configured to change the first pseudonym and the translator is further configured to detect the change in the first pseudonym and to translate communications from the user to the customer-contact associated with the customer-contact domain by mapping the changed first pseudonym to the second pseudonym.

17. The communications network of claim 11, wherein the translator is further configured to electronically map the first pseudonym to the second pseudonym.

18. A computer program product for operating a communication network
a computer readable storage medium having computer readable program code embodied therein, the computer readable program code comprising:
computer readable program code configured to associate a first pseudonym with a user of the communication network in a customer domain;
computer readable program code configured to associate a second pseudonym with the user in a customer-contact domain; and
computer readable program code configured to translate communications between the user and a customer-contact associated with the customer-contact domain by mapping the first pseudonym and the second pseudonym to each other.

19. The computer program product of claim 18, wherein the computer readable program code configured to translate communications from the user to a customer-contact associated with the customer-contact domain comprises:
computer readable program code configured to map the first pseudonym to a translator domain pseudonym; and
computer readable program code configured to map the translator domain pseudonym to the second pseudonym.

20. The computer program product of claim 19, wherein the translator domain pseudonym is ephemeral.
